(19) United States
(12) Patent Application Publication
(10) Pub. No.: US 2026/0237704 A1
(43) Pub. Date: Aug. 13, 2026

(54) Methods And Devices For Continuous Removal of Impurities From Electrolytes

(71) Applicant: Lockheed Martin Energy, LLC, Bethesda, MD (US)

(72) Inventors: Emily Nelson, Andover, MA (US); Steven Y. Reece, Lincoln, MA (US); Sunaro Chan, Scarborough, ME (US); Udit Ghote, Ahmedpur (IN); Siddharth Bhanushali, Mumbai (IN)

(21) Appl. No.: 19/050,293

(22) Filed: Feb. 11, 2025

(51) Int. Cl. H01M 8/0662; H01M 8/18

(52) U.S. Cl. CPC H01M 8/0681; H01M 8/184

(57) ABSTRACT

A continuous process for preparing an electrolyte solution having reduced impurity levels is described. The process comprises at least electrochemically reducing an impurity, the impurity being present at an initial concentration, contained within an initial electrolyte solution also comprising a redox active electrolyte. The electrochemically reducing conditions are sufficient to generate an electrochemically treated electrolyte solution containing a reduced form of the redox active electrolyte and a reduced form of the impurity. The reduced form of the impurity is separated from the electrochemically treated solution, so as to provide a final electrolyte solution having a final concentration of the impurity that is less than the initial concentration of the impurity. In some embodiments, the process further comprises the step of oxidizing the purified electrolyte solution.

### TECHNICAL FIELD

The present disclosure relates to methods and devices for purifying electrolytes, including electrolytes comprising redox active materials, and the purified electrolytes prepared therefrom.

### BACKGROUND

The problems associated with the presence of certain impurities including arsenic, antimony, tin, and other such metals in redox flow battery systems, and battery systems in general, are well known. For example, U.S. Pat. Nos. 9,647,290; 9,985,311; and 11,233,260 describe issues associated with arsenic, antimony, and germanium precipitating from vanadium flow battery systems, and these patents also describe the need to maintain levels of these materials and other metals and metalloids including Cr, Mn, Fe, Co, Ni, Cu, Zn, Mo by selection of raw materials.

U.S. Pat. Nos. 8,852,777 and 8,951,665 both describe issues associated with Hg, Ni, Co, and Cu impurities in iron-chrome-based redox flow battery electrolytes, and these patents seek to remedy or avoid problems with these materials using zinc amalgam or other inorganic reductants. These methods, however, appear to be singularly applicable to solutions of iron ions and chromium with an acid.

U.S. Pat. No. 12,074,353 describes a general method for removing impurities from electrolytes. There are, however, few methods that are effective for removing impurities in a manufacturing process, such as a continuous process of purifying electrolytes.

The present application is directed to addressing these and other problems.

### BRIEF SUMMARY

In meeting the described long-felt needs, a continuous process for preparing an electrolyte solution having reduced impurity levels is described. The process comprises at least electrochemically reducing an impurity, the impurity being present at an initial concentration, contained within an initial electrolyte solution also comprising a redox active electrolyte. The electrochemically reducing conditions are sufficient to generate an electrochemically treated electrolyte solution containing a reduced form of the redox active electrolyte and a reduced form of the impurity. The reduced form of the impurity is separated from the electrochemically treated solution, so as to provide a final electrolyte solution having a final concentration of the impurity that is less than the initial concentration of the impurity. In some embodiments, the process further comprises the step of oxidizing the purified electrolyte solution.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is graph showing the Ti³⁺ concentration in the first, second, and third electrochemical reactors of Example 1 described herein, as the process is started.

FIG. 2 is a graph of the volume in the first, second, and third electrochemical reactors of Example 1, as the process is started.

FIG. 3 is a graph of arsenic concentration as the number of gas removal column passes increases in the process of Example 1.

FIG. 4 is a graph showing the Ti³⁺ concentration as the number of steel packed bed column passes increases in the process of Example 1.

FIG. 5 is a schematic of a flow diagram of an example embodiment of the disclosed process.

### DETAILED DESCRIPTION

A continuous process for removing impurities from an electrolyte solution allows larger amounts of electrolyte to be purified and without significant startup and shutdown issues. Initiating a batch electrolytic process can require widely varying current and voltages which can result in high resistances and excessive heat generation. These changes can put large pressures on the membrane used in the electrochemical cell which can weaken, rupture, or reduce the efficiency of the membrane. Electrolyte solutions (posolyte, negolyte, or both) can be purified by the described process.

Provided here is, inter alia, a continuous process for preparing an electrolyte solution having reduced impurity levels. The process comprises at least electrochemically reducing an impurity, the impurity being present at an initial concentration, contained within an initial electrolyte solution also comprising a redox active electrolyte. The electrochemically reducing conditions are sufficient to generate an electrochemically treated electrolyte solution containing a reduced form of the redox active electrolyte and a reduced form of the impurity. The reduced form of the impurity is separated from the electrochemically treated solution, so as to provide a final electrolyte solution having a final concentration of the impurity that is less than the initial concentration of the impurity.

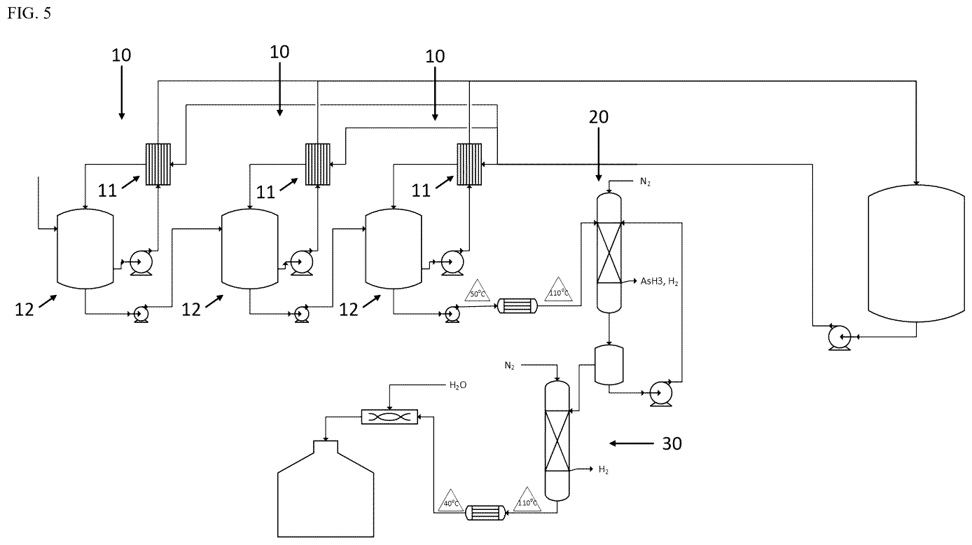

The continuous process for removing impurities from an electrolyte solution comprises multiple steps. The initial electrolyte solution comprises an impurity at an initial concentration and a redox active electrolyte. The electrolyte solution is reduced by flowing the initial electrolyte solution through one or more electrochemical reactors (10) to electrochemically reduce at least a portion of the redox active electrolyte to form a reduced form of the redox active electrolyte and electrochemically reduce at least a portion of the impurity to form a reduced form of the impurity in an electrochemically treated electrolyte solution. The electrochemically treated electrolyte solution is heated. The heated electrochemically treated electrolyte solution is flowed through a gas removal column (20) to remove the reduced form of the impurity to form a purified electrolyte solution. FIG. 5 provides a schematic of an embodiment of the process.

The electrochemical reduction can be performed by passing an electric current through the electrolyte solution. Desirably, the reduction is performed at an oxidation/reduction potential that is more negative than the reduction potential of the impurity. The oxidation/reduction potential required is selected based on the impurity to be removed from the electrolyte.

The nature and initial concentrations of the impurities can depend on the nature and concentrations of the redox active electrolytes and other materials used in the formulation of the initial electrolyte solution. For example, vanadium-containing electrolytes are known to contain metal elements such as Sb, As, Cr, Mn, Fe, Co, Ni, Cu, Zn, Mo, or Sn. These same types of impurities can exist in other metal-containing redox active electrolytes. In some embodiments, the impurity comprises one or more forms of antimony, arsenic, germanium, mercury, tin, or a combination thereof.

In some embodiments, the process allows that the final concentration of the impurity in the final electrolyte solution can be tuned to a pre-determined threshold level. For example, in some embodiments, the final concentration of the impurity in the final electrolyte solution can be any of the impurity levels described herein. Examples of pre-determined threshold levels are: less than about 10 mg of one or more of a given impurity per liter of redox active electrolyte solution (“mg/L”), less than 5 mg/L, less than 2.5 mg/L, less than 1 mg/L, less than 500 μg of one or more of a given impurity per liter of redox active electrolyte solution (“μg/L”), less than 250 μg/L, less than 100 μg/L, less than 50 μg/L, less than about 40 μg/L, less than about 30 μg/L, less than about 20 μg/L, less than about 10 μg/L, less than about 5 μg/L, or less than about 1 μg/L of one or more of a given impurity. Further examples of pre-determined threshold levels are: less than about 10 mg of one or more of a given impurity per mole of the redox active electrolyte in the redox active electrolyte solution (“mg/mol”), less than 5 mg/mol, less than 2.5 mg/mol, less than 1 mg/mol, less than 500 μg of one or more of a given impurity per mole of redox active electrolyte (“μg/mol”), less than 250 μg/mol, less than 100 μg/mol, less than 50 μg/mol, less than about 40 μg/mol, less than about 30 μg/mol, less than about 20 μg/mol, less than about 10 μg/mol, less than about 5 μg/mol, or less than about 1 μg/mol of one or more of a given impurity in the redox active electrolyte solution. In some embodiments, this is less than 5 μg/L or 5 μg/mol for Sb and As and less than 10 μg/L or 5 μg/mol for Ge and Sn. In some embodiments, the impurity is a form of antimony, arsenic, germanium, tin, or a combination thereof. In other aspects, the impurities can also comprise Hg, Cr, Mn, Fe, Co, Ni, Cu, Zn, or Mo.

The processes can also be characterized by their efficiencies in removing the impurities, and reducing their initial levels to the final, pre-determined levels. In some embodiments, the final impurity levels represent a 50% reduction of the impurities, relative to their initial levels. In some embodiments, the processes provide final redox active electrolyte solutions in which the final impurity concentration is at least 75%, 80%, 85%, 90%, 95%, 98%, 99%, or 99.9% lower than the concentration in the initial solution.

For the electrochemical reduction to be effective, it is performed at an oxidation reduction potential that is more negative than the reduction potential of the impurity in the presence of the redox active electrolyte. As different impurities have different reduction potentials, the skilled artisan should select the appropriate reduction potential for the target impurity. For present purposes, it is immaterial whether the impurity is directly reduced under the conditions applied, or indirectly from the reduced form of the redox active material (or vice versa), as long as the impurity is reduced. While it may happen that the presence of a given redox active electrolyte may affect the reduction potential of the impurity, to a first approximation the reduction potential of the impurities can be determined, or are known, independent of the presence of the redox active electrolyte, and for this reason, determining the exact reduction potential would be within the capabilities of a person of skill in the art. Also, the effects of pH on standard reduction potential are known and again the person of skill in the art would be able to accurately predict the appropriate potential to apply to effect the desired transformation.

In some embodiments, the nature of the impurity is such that the reduced form of the impurity is a volatile hydride. In some embodiments the impurity comprises any one or more of a form of antimony, arsenic, germanium, or tin. In some embodiments, volatile hydride comprises any one or more of arsine (AsH₃), germane (GeH₄), stannane (SnH₄), or stibine (SbH₃).

Where the processing results in the formation of a volatile reduced impurity, such as a volatile hydride, further steps can be helpful in removing that volatile material. Such “conditioning” steps can comprise heating the electrochemically treated electrolyte solution under inert atmosphere conditions at a temperature above ambient temperature, up to the boiling point of the electrochemically treated or final electrolyte solutions. For most commercially relevant systems, the boiling point of the final aqueous electrolyte solution is on the order of 105° C. to 110° C. In some embodiments, then, such heating can be applied to a temperature in a range of or including one or more of from 20° C. to 25° C., from 25° C. to 30° C., from 30° C. to 35° C., from 35° C. to 40° C., from 40° C. to 45° C., from 45° C. to 50° C., from 50° C. to 55° C., from 55° C. to 60° C., from 60° C. to 65° C., from 65° C. to 70° C., from 70° C. to 75° C., from 75° C. to 80° C., from 80° C. to 85° C., from 85° C. to 90° C., from 90° C. to 95° C., from 95° C. to 100° C., from 100° C. to 105° C., or from 105° C. to 110° C., for example from 35° C. to 95° C., or from 45° C. to 85° C. In some embodiments, the heated electrochemically treated electrolyte solution is passed through a gas removal column to remove the reduced form of the impurity to form a purified electrolyte solution. In some embodiments, the heated solution is recirculated through the gas removal column. The gas removal column has a high surface area. In some embodiments, the gas removal column has a surface area such that the liquid passing through the column is able to form a film of about 1 to about 10 mm in thickness over the surface area. In some embodiments, the film is about 1 to 5 mm in thickness.

In some embodiments, in addition to heating, such “conditioning” steps can comprise purging or sparging the heated solution using an inert gas, such as nitrogen or argon. It can be useful to maintain the reduced impurity in its volatile form. The purging can be performed by bubbling the inert gas thought the heated solution to transfer of the dissolved reduced form of the impurity into the gas phase and removal from the electrolyte. The flow rate of the purging gas is about 0.5 to about 5 times that of the heated solution flow rate, such as about 1 to about 2 times the heated solution flow rate.

It is appreciated that, increasing the temperature of an electrolyte can foster the oxidation of a charged redox active electrolyte or the reduced impurity, resulting in hydrogen evolution. To avoid this, the temperature should be selected such that such oxidation is avoided (e.g., so that the electrolyte remains charged and/or the oxidation of the escaping hydride back to a soluble, non-volatile state is prevented). Alternatively, or additionally, the operator can maintain the electrolyte solution at an appropriate electric potential (i.e., that is more negative than the reduction potential of the impurity and/or the redox active electrolyte) during the course of the heating.

After at least a portion of the reduced form of the impurity has been removed, and the level of impurity in the final electrolyte solution is at its appropriate level, the redox active material can be in its fully reduced/charged state. In some embodiments, the process further comprises the step of oxidizing the purified electrolyte solution. Whether for safety or any other reason (for example, to minimize unintentional oxidation accompanied by hydrogen evolution during transport of the final electrolyte solution), it can be desirable to lower the state of charge of the final electrolyte solution (i.e., to at least partially discharge the redox active electrolyte). This can be accomplished by any appropriate oxidation method. For example, this can be done chemically, by purging with an oxidizing gas, such as air or oxygen, or through use of a chemical oxidizing agent, such as hydrogen peroxide, or electrochemically, by using a hydrogen evolution catalyst (e.g., activated carbon, carbon cloth, carbon felt, carbon paper, Ti mesh, Ti felt, expanded Ti mesh, Pt-plated Ti mesh, or a combination thereof), or by some combination of these methods. In some embodiments, the purified electrolyte solution is oxidized by flowing the purified electrolyte solution through a vessel comprising metal to oxidize the reduced form of the redox active electrolyte in the purified electrolyte solution. This forms the final electrolyte solution with the redox active electrolyte. In some embodiments, the vessel comprising metal is a packed bed column (30). In some embodiments, the oxidation is performed using a hydrogen evolution catalyst. Examples of the hydrogen evolution catalyst include activated carbon, carbon cloth, carbon felt, carbon paper, Ti mesh, Ti felt, expanded Ti mesh, Pt-plated Ti mesh., stainless steel, and mild steel. The reagents or methods for such oxidations are preferably chosen such that no deleterious materials are introduced.

The oxidations can be conducted at ambient or reduced or elevated temperatures. In certain embodiments, the final electrolyte solutions are oxidized at one of more temperatures of at least 65° C. or greater, such as a temperature of about 65° C. to about 130° C., preferably at a temperature of about 85° C. to 130° C., more preferably at a temperature of about 105° C. to 130° C. In certain circumstances, the application of heat and/or sparging can also be helpful, and in fact can intentionally be used to further concentrate the redox active electrolyte in the final redox active solution.

### Process

In some embodiments, the step of reducing the electrolyte solution comprises flowing the electrolyte solution sequentially into a plurality of electrochemical reactors, such as 2 to 10, 2 to 7, or 2 to 5 electrochemical reactors. In each electrochemical reactor at least a portion of the redox active electrolyte is electrochemically reduced to form a reduced form of the redox active electrolyte or at least a portion of the impurity is electrochemically reduced to form a reduced form of the impurity. With each sequential electrochemical reactor, more of the redox active electrolyte is electrochemically reduced and/or a portion of the impurity is electrochemically reduced. In some embodiments, in the first electrochemical reactor the redox active electrolyte is electrochemically reduced to the reduced form of the redox active electrolyte to result in about 5 mol % to about 30 mol % of the reduced form of the redox active electrolyte out of the total amount of redox active electrolyte in the electrochemically treated electrolyte solution. This means that when the electrolyte solution leaves the first electrochemical reactor to pass into the second electrochemical reactor, about 5 mol % to about 30 mol % of the redox active electrolyte will be in the reduced form. For example, there can be about 5 mol % to about 10 mol %, about 10 mol % to about 15 mol %, about 15 mol % to about 20 mol %, about 20 mol % to about 25 mol %, or about 25 mol % to about 30 mol %. In some embodiments, the reduction step performed in the first electrochemical reaction is at an oxidation reduction potential that is about 25% to about 50% of the oxidation reduction potential of the impurity. For example, the oxidation reduction potential is about 25% to about 30%, about 30% to about 35%, about 35% to about 40%, about 40% to about 45%, or about 45% to about 50% of the oxidation reduction potential of the impurity.

In some embodiments, in the last electrochemical reactor the redox active electrolyte is electrochemically reduced to the reduced form of the redox active electrolyte to result in about 25 mol % to about 40 mol % of the reduced form of the redox active electrolyte out of the total amount of redox active electrolyte in the electrochemically treated electrolyte solution. This means that when the electrolyte solution leaves the last electrochemical reactor, about 25 mol % to about 40 mol % of the redox active electrolyte will be in the reduced form out of the total amount of redox active electrolyte. For example, there can be about 25 mol % to about 30 mol %, about 30 mol % to about 35 mol %, or about 35 mol % to about 40 mol %. When the electrolyte solution leaves the last electrochemical reactor, more than 50 mol % of the impurity will be in the reduced form of the impurity. Such as about 50 mol % to about 99.9 mol %, about 60 mol % to about 99.9 mol %, 70 mol % to about 99.9 mol %, 80 mol % to about 99.9 mol %, 90 mol % to about 99.9 mol %, 95 mol % to about 99.9 mol %, 97 mol % to about 99.9 mol %, 98 mol % to about 99.9 mol %, or 99 mol % to about 99.9 mol %. In some embodiments, the reduction step performed in the list electrochemical reaction is at an oxidation reduction potential that is about 100% to about 150% of the oxidation reduction potential of the impurity. For example, the oxidation reduction potential is about 100% to about 105%, about 105% to about 110%, about 110% to about 115%, about 115% to about 120%, about 120% to about 125%, about 125% to about 130%, about 130% to about 135%, about 135% to about 140%, about 140% to about 145%, or about 145% to about 150% of the oxidation reduction potential of the impurity.

The electrolyte solution sequentially flows into the electrochemical reactors. The electrolyte solution will have a residence time in each of the electrochemical reactors. In some embodiments, the mean residence time in each reactor is from about 30 minutes to about 6 hours, such as about 30 minutes to about 1 hour, about 1 hour to about 1.5 hours, about 1.5 hours to about 2 hours, about 2 hours to about 2.5 hours, about 2.5 hours to about 3 hours, about 3 hours to about 3.5 hours, about 3.5 hours to about 4 hours, about 4 hours to about 4.5 hours, about 4.5 hours to about 5 hours, about 5 hours to about 5.5 hours, about 5.5 hours to about 6 hours.

Each electrochemical reactor comprises an electrochemical cell (11) and a vessel (12). A fraction of the electrolyte solution in the vessel is circulated through the electrochemical cell. The electrolyte solution can be circulated through the electrochemical cell multiples times. The electrochemical reactor functions as a recycle reactor. An example of the electrochemical cell (11) is a HERM device.

### Electrochemical Devices (HERM Devices)

HERM devices are described in U.S. Pat. No. 12,074,353, granted on Aug. 27, 2024, which is herby incorporated in its entirety.

To be operative, the chemistries require devices/systems that “inject” electrons into the electrolyte solution, the electrolyte solution containing the redox active material, at a potential sufficient to reduce the reducible impurity. Not previously discussed is the effect or nature of the counterbalancing cation that must necessarily accompany the injected electrons. However, the specific choice of device/system (hereafter referred to as “HERM device” or Hybrid Electrochemical Removal Modular device) used depends on the electrolyte being “cleaned” (i.e., the solution containing the redox active material from which the impurity is being cleaned). The choice of system also needs to consider the state of charge of the redox active material and that the amounts of impurities (even if taken as 100 mg/L or 100 ppm) relative to the redox active material in any practical electrolyte solution (typically greater than 0.5 M) being cleaned will be very small. Consider, for example, a hypothetical one-liter solution of an electrolyte solution containing 1 M redox active material at 50% state of charge containing 100 ppm of a reducible impurity. Nearly all the electrons pumped into such a system will be used to reduce the redox active material and only a small proportion will be used to reduce the reducible impurity. The electrons required to reduce the state of charge of the redox active material can be several orders of magnitude greater than that necessary to reduce the reducible material. And in any such system, these electrons will be accompanied by an equal amount of counterbalancing cations.

Whether the electrolyte being treated is acidic or alkaline, an injection of hydrogen ions at these levels will generally result in a concentration that is much higher than the hydrogen ion content of the electrolyte being treated (even at a pH=2, the [H⁺]=0.01 M). Such an injection will have a significant impact on changing the pH of the treated electrolyte. This can be resolved by pH adjusting the electrolyte solution with an appropriate base after the reduction step is completed, but even the addition of bases can introduce significant impurities to the purified electrolyte solutions. A more elegant solution is to use a HERM device that simultaneously injects alkali metal or alkaline earth metal (or other non-protic) cations with the electrons.

Devices previously described for pH balancing a system include those described in WO 2015/048074 (the '074 Application), the contents of which are incorporated by reference herein for all purposes, but at least for its teaching of the hardware and methods of use describe therein. The '074 application teaches equipment and methods for simultaneously balancing both the electron and proton contents of working electrolytes. As described therein, the device described as a rebalancing cell or balancing cell describes devices and methods for injecting both electrons and protons into a redox active electrolyte solution. While principally described in terms of affixed to a working flow battery, the description also describes the rebalancing cell as a stand-alone device. Several embodiments discussed in the '074 application, and which are set forth herein, include those where the balancing cell comprises:
(1) a first and second half-cell chamber, wherein the first half-cell chamber comprises a first electrode in contact with a first aqueous electrolyte of the redox flow battery; and wherein the second half-cell chamber comprises a second electrode in contact with a second aqueous electrolyte, said second electrode comprising a catalyst for the generation of O₂. In some of these embodiments, the pH of the second aqueous electrolyte is at least 2 preferably greater than about 7, more preferably in a range of about 9 to about 14. In other embodiments, there is no added second electrolyte.
(2) a first half-cell chamber with a first electrode in contact with a first aqueous electrolyte of the redox flow battery; the second half-cell chamber comprises a second electrode in contact with a second aqueous electrolyte, said second electrode comprising a sacrificial carbon electrode material for the generation of O₂ and/or CO₂. The two half-cell chambers are separated by an ion exchange ionomer membrane.
(3) a first half-cell chamber with a first electrode in contact with a first aqueous electrolyte of the redox flow battery; the second half-cell chamber comprises a second electrode comprising a catalyst for the generation of O₂ but said electrode is not in contact with a second aqueous electrolyte. The two half-cell chambers are separated by an ion exchange ionomer membrane.

In some embodiments, the first aqueous electrolyte is described as comprising a negative working electrolyte (“negolyte”) of the redox flow battery. In some embodiments, the electrochemistry associated with the second half-cell of the balancing cell at acidic or neutral pH values is described in terms of Equation (1):

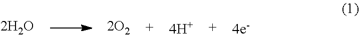

and at more basic pH values, the electrochemistry associated with the second half-cell of the balancing cell is described in terms of Equation (2):

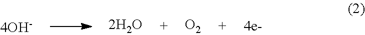

The corresponding electrochemical reactions associated with the first half-cell can be described in Equation (3):

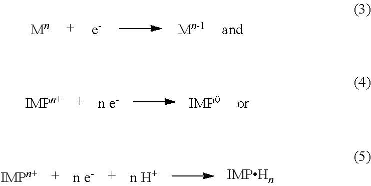

where Mⁿ and Mⁿ⁻¹ represent the oxidized and reduced forms of redox active species in the negolyte, respectively, corresponding in the present application to the redox active material in the solution to be treated, where “IMPⁿ⁺ refers to an initial form of an impurity (e.g., As³⁺) and IMP⁰ and IMP.Hₙ refer to the reduced metallic or hydride forms of the impurity, respectively. In the present context, two such reaction schemes can be seen in equations (6) and (7):

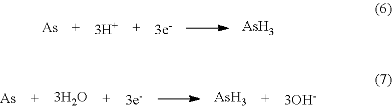

Because the '074 Application is directed to simultaneous balancing of the electron and proton contents of the working electrolyte solutions, in both situations, the transport of protons through the membrane from the second to first half-cell of the pH correction cell is said to provide the charge balance to the negolyte. As one of the consequences of this design, the '074 Application describes that when the second half-cell chamber comprises a second electrode comprising a catalyst for the generation of O₂ operated in an alkaline environment, the two half-cell chambers are separated by a bipolar membrane consisting of one cation exchange and one anion exchange ionomer membrane sandwiching a metal oxide film that facilitates water dissociation. It is through the use of a bipolar membrane that the balancing cell is described as operating while deploying an alkaline electrolyte in the second half-chamber.

However, in the present case, for reasons described above, it is less desirable to simultaneously pump electrons and protons (as described in the '074 Application), and more desirable to simultaneously pump electrons and other non-protic cations into an electrolyte solution. As such, the devices described in the '074 Application can be reconfigured to simultaneously pump electrons and non-protic cations by incorporating alkali or alkaline earth metal cations (or even ammonium cations) in the second electrolyte at a concentration sufficient to prevent the need for pH adjustment of the first aqueous electrolyte after electrochemical treatment. In preferred embodiments, the alkali or alkaline earth metal cations (or even ammonium cations) in the second electrolyte are present at a concentration that is much greater (e.g., greater than 10, 100, 500, 1000, 5000, or 10,000 times higher than the concentration of protons in the second electrolyte). In certain embodiments, these non-protic cations can be alkali or alkaline earth metal cations, for example Li⁺, Na⁺, K⁺, [NHₙR₄₋ₙ]⁺ (R=alkyl), or mixtures thereof. These non-protic cations can be present in the second aqueous electrolyte in a concentration range of at least 0.1 M to their saturation concentrations, or in a range of from 0.1 M to 0.2 M, from 0.2 M to 0.3 M, from 0.3 M to 0.4 M, from 0.4 to 0.5 M, from 0.5 M to 0.6 M, from 0.6 M to 0.7 M, from 0.7 M to 0.8 M, from 0.8 to 0.9 M, from 0.9 M to 1 M, from 1 M to 1.25 M, from 1.25 M to 1.5 M, from 1.5 M to 2 M, or higher, or any combination thereof. Exemplary counterions to these cations include hydroxides, phosphates, sulfates, or aminopolycarboxylates, such as EDTA and DTPA.

In the present case, a similar system as that described in the '074 Application (including the aspect of its hardware) can be used as a HERM device, either attached to a flow battery as described in the '074 Application, or as attached to a storage tank or vessel, and/or divorced from a working system. Because the HERM device is not used in conjunction with a working flow battery system, voltage and other efficiencies of the HERM device do not necessarily relate to the economics of such a flow battery system.

In some embodiments, the electrochemical cell comprises a first and second half-cell chamber separated by a membrane, wherein:
the first half-cell chamber comprises a first electrode, preferably a carbon electrode such as carbon cloth, carbon felt, or carbon paper, in contact with a first aqueous electrolyte containing a redox active electrolyte (e.g., a negolyte) and a reducible impurity; and
the second half-cell chamber comprises a second electrode in contact with a second aqueous solution, preferably basic, but having a pH of at least 10, said second electrode comprising a catalyst for the generation of O₂, preferably at least one of carbon, copper, nickel, or a combination thereof.

In some embodiments, then, the present disclosure contemplates an electrochemical cell comprising a first and second half-cell chamber separated by a membrane, wherein:
the first half-cell chamber comprises a first electrode, preferably a carbon electrode, in contact with a first aqueous electrolyte containing a redox active material and a reducible impurity; and
the second half-cell chamber comprises a second electrode in contact with a second aqueous solution, said second electrode comprising a catalyst for the generation of O₂, preferably comprising nickel such as Ni foam, stainless steel mesh, stainless steel felt, Ni oxide, Ni hydroxide, Ni oxy-hydroxide, or Ni—Fe oxide.

In some embodiments, the electrochemical cell comprises 2-100 cells in the electrochemical cell stack, preferably 5-11 cells. In some embodiments, the electrochemical cell has a total stack voltage of 10-300 V, preferably 20-50 V. In some embodiments, the electrochemical cell operates at a current density of 0.1-0.4 A/cm², preferably 0.1-0.2 A/cm².

In some embodiments, the membrane is a cation exchange membrane (“CEM”). In these embodiments, the membrane is not a bipolar membrane as described in the '074 Application and does not contain an incorporated anion exchange membrane. Materials useful for these cation exchange membranes include perfluoro- or polyfluorosulfonic acid membranes (NAFION™, AQUIVION™, or FLEMION™ membranes) including copolymers of tetrafluoroethylene, optionally comprising perfluoropolyvinyl ethers, sulfonated hydrocarbon membranes (sulfonated polyether ether ketone, sulfonated polyphenyl sulfone). Examples include NAFION™ 300 or 400 series, e.g. N324 or N424. In some embodiments, the membrane is reinforced. Other exemplary perfluorinated membrane materials include copolymers of tetrafluoroethylene and one or more fluorinated, acid-functional co-monomers. Other useful perfluorinated electrolytes comprise copolymers of tetrafluoroethylene (TFE) and FSO₂—CF₂CF₂CF₂CF₂—O—CF═CF₂.

In some embodiments, the second aqueous electrolyte is free of redox active materials. In still other embodiments, the second aqueous electrolytes contain non-protic cations at levels discussed elsewhere herein for this purpose. Preferably the type and proportion of the non-protic cations of the second solution approximately or actually match that of the electrolyte solution being treated (in the first half-cell). The term “approximately match” refers to a distribution that does not require that the cation content in the redox-containing electrolyte needs adjustment after treatment. Without being bound to any particular theory or embodiment, the mobility of the respective cations through the membrane may require that the relative proportions of the cations in the second electrolyte solution differ slightly from the corresponding proportions in the electrolyte being treated. The ability to determine these differences, if at all necessary, can be identified without undue experimentation by the skilled artisan.

In some embodiments, the pH of the first and second aqueous electrolytes are both less than seven, are both about seven, or are both greater than seven. Such devices and methods can be used to treat highly acidic redox active electrolytes, such as exist, for example, in vanadium or iron-chrome flow batteries, and alkaline or PH neutral redox active electrolytes, for example based on metal-ligand coordination compounds, such as titanium-based negolyte materials (and also including the broader range of negolytes described herein).

Preferably, the pH of the first and second aqueous electrolytes differ by less than 5 pH units. In some embodiments, the electrolytes differ by less than 4, 3, 2, or 1 pH units. If higher, strategies using pH buffering layers, such as described in PCT/US2018/054798, filed Oct. 8, 2018 can also be employed, which is herein incorporated by reference in its entirety.

As described above, the second electrode generally comprises a catalyst for the generation of O₂. In some embodiments, the second electrode comprises a metal oxide catalyst, said metal oxide catalyst being suitable for the electrochemical generation of O₂ from water. In addition to the ability to generate O₂, these oxidation catalysts preferably resist corrosion under the pHs considered in this application, are poor catalysts for the reduction of water to hydrogen, or both. Catalysts which corrode under the acidic or basic oxidizing conditions of the operating second aqueous electrolyte have the potential to cross-over to the first pH correction half-cell, interfering with either the intended effect of the pH correction cell or, worse, with the operation of the flow battery. If such cross-over catalysts are further efficient catalysts for the generation of hydrogen under the reducing conditions of the first half-cell, one can envision scenarios where the evolution of hydrogen in the first half-cell or at the negative electrode of the working flow battery causes safety concerns. Accordingly, in some embodiments, of oxides of cobalt, iridium, iron, manganese, nickel, ruthenium, tin, or a combination thereof are used in the second electrode. Iridium oxide is especially preferred, because of its good catalytic activity toward O₂ evolution and its high corrosion resistance.

In case the second half-chamber comprises an alkaline electrolyte, catalysts such as nickel or nickel-iron oxide are especially preferred because of their good catalytic activity toward O₂ evolution and their high corrosion resistance in base. Suitable materials here include Ni foam, stainless steel mesh, stainless steel felt, Ni oxide, Ni hydroxide, Ni oxy-hydroxide, or Ni—Fe oxide.

In some embodiments, the second electrode of the HERM device comprises carbon. Such electrodes are well known in the art and include graphitic carbon, glassy carbon, amorphous carbon, carbon doped with boron or nitrogen, diamond-like carbon, carbon onion, carbon nanotubes, carbon cloth, carbon felt, carbon paper, and graphene. Carbon materials are capable of evolving O₂, albeit at rather high overpotentials, but it is inevitable that the carbon electrode itself will be oxidized into CO₂. As such, the carbon electrodes are semi-sacrificial of nature. In other embodiments, the second electrode can also comprise Ti mesh, Ti felt, expanded Ti mesh, stainless steel mesh, and stainless steel felt.

In some embodiments, the electrochemical cells comprise a first and second half-cell chamber separated by a membrane, wherein
(i) the first half-cell chamber comprises a first electrode in contact with a first aqueous electrolyte containing a redox active material and a reducible impurity; and
(ii) the second half-cell chamber comprises a second electrode comprising a catalyst for the generation of O₂; and wherein the second half-cell chamber does not contain (is free of) an aqueous electrolyte.

In this configuration, the water required for the O₂ evolution reaction is provided by water from the aqueous electrolyte in the first half-chamber that is transported across the membrane. To avoid the situation of mass transport limitations, the water transport across the membrane needs to be faster than the consumption of water at the metal oxide catalyst. The membrane on the side of the second half-chamber is coated with a metal oxide O₂ evolution catalyst (e.g. IrOₓ) as a result of which water that is transported from the first half-chamber across the membrane is directly oxidized into molecular oxygen and protons. This configuration can simplify the design of the electrochemical device. For instance, the metal oxide catalyst on the membrane can be directly interfaced with the titanium endplate, omitting the need for the titanium meshes that act as a flow field for the second aqueous electrolyte. The only additional design feature would be a vent for the molecular oxygen that is evolved at the metal oxide catalyst. Furthermore, water would have to be added periodically to the negolyte electrolyte tank to compensate for water that is consumed in the O₂ evolution reaction. Optionally, this make-up water can be produced in-situ by combining the evolved O₂ from the second half-chamber with the H₂ evolved in the second half chamber of the electrochemical cell of the HERM device and in the negolyte compartment of the first cell. This water production process can be catalyzed by a noble metal catalyst (e.g. Pt, Pd, etc.).

Additional embodiments provide methods of operating any of these HERM devices described herein, each method comprising applying an electric potential across said first and second electrodes of the devices and supplying current to the device in the presence of the aqueous electrolyte being treated. The specific conditions for such operation are described elsewhere herein. When operating to remove impurities from electrolyte solutions containing these redox active materials, parasitic hydrogen evolution does not impede its primary function. This allows the use of less expensive materials, such as stainless steel in the construction of the electrodes.

### Terms

Throughout this specification, words are to be afforded their normal meaning, as would be understood by those skilled in the relevant art. However, so as to avoid misunderstanding, the meanings of certain terms will be specifically defined or clarified.

Unless otherwise specified, the term “aqueous” refers to a solvent system comprising at least about 98% by weight of water, relative to total weight of the solvent. In some applications, soluble, miscible, or partially miscible (emulsified with surfactants or otherwise) co-solvents can also be present which, for example, extend the range of water's liquidity (e.g., alcohols/glycols). When specified, additional independent embodiments include those where the “aqueous” solvent system comprises at least about 55 wt %, at least about 60 wt %, at least about 70 wt %, at least about 75 wt %, at least about 80%, at least about 85 wt %, at least about 90 wt %, at least about 95 wt %, or at least about 98 wt % water, relative to the total solvent. It some situations, the aqueous solvent can consist essentially of water, and be substantially free or entirely free of co-solvents or other species. The solvent system can be at least about 90 wt %, at least about 95 wt %, or at least about 98 wt % water, and, in some embodiments, be free of co-solvents or other species.

As used herein, the terms “aqueous electrolyte,” “electrolyte solution,” and variations thereof (generally referred to as “electrolyte”), are intended to connote a solvent system comprising at least one material, whose conductivity is higher than the solvent system without the material.

The terms “electrochemically active electrolyte,” or “redox active electrolytes,” and variations thereof carry their normal connotations to those skilled in the art of electrochemistry. These terms typically are intended to connote those electrolyte compositions (compounds or solutions) capable of a redox transition; that is, capable of changing oxidation state or valence state upon the application of electric potential, by the capture or release of at least one electron. In the context of metal ligand coordination compounds, the metal can have multiple accessible valence states and be said to be redox active, or the ligand can be capable of accepting/releasing electrons and be said to be redox active, or a redox active material can contain one or both of redox active metals and ligands.

The electrolyte can contain various redox active materials. Examples of the electrolyte include vanadium-based electrolytes containing vanadium ions as an active material for both electrodes, iron-chromium-based electrolytes containing iron ions as a positive electrode active material and chromium ions as a negative electrode active material, manganese-titanium-based electrolytes containing manganese ions as a positive electrode active material and titanium ions as a negative electrode active material, manganese-titanium-based electrolytes containing manganese ions and titanium ions for both electrodes, among others.

In some embodiments, the electrochemically active electrolyte comprises a metal ligand coordination compound. In some embodiments, the electrochemically active electrolyte comprises a metal ligand coordination compound comprising a redox active metal ion and/or a redox inert metal ion. Preferably, the redox active metal ion or redox inert metal ion is Al, Ca, Co, Cr, Sr, Cu, Fe, Mg, Mn, Mo, Ni, Pd, Pt, Ru, Sn, Ti, V, Zn, or Zr, or a combination thereof. In other embodiments, the electrochemically active electrolyte comprises an organic active material. Preferably, the organic active material is carbon, an aromatic hydrocarbon, or a combination thereof. Example of aromatic compounds include, without limitation, a quinone, hydroquinone, viologen, pyridinium, pyridine, acridinium, or catechol, any of which can be unsubstituted, substituted, or combinations thereof. In some preferred embodiments, the electrolyte comprises a vanadium-based electrolyte. In some embodiments, the initial electrolyte solution comprises the redox active electrolyte at a concentration of from about 0.5 M to about 2 M.

In addition to the redox active materials, the electrolyte can contain additional components such as solvents, buffering agents, supporting electrolytes, viscosity modifiers, wetting agents, and the like. The electrolytes can also contain metal elements, including heavy metals, as impurities, as defined herein. Examples of solvents include aqueous solutions comprising at least one of H₂SO₄, K₂SO₄, Na₂SO₄, H₃PO₄, H₄P₂O₇, K₂HPO₄, Na₃PO₄, K₃PO₄, HNO₃, KNO₃, HCl, NaNO₃, NaOH, or KOH. Alternatively, the solvent can be an organic acid solvent.

As used herein, the term “impurity” connotes its recognized meaning as referring to an unwanted species, typically comprising a metal or metalloid, which is not intended to participate in the functioning of an electrochemical cell, as in a fuel cell or flow battery context, and in many cases, is deleterious to the safe and efficient use of the electrochemical cell. It is typically adventitiously present, introduced as an impurity (in the conventional sense of the word) with the intended materials. For example, as discussed elsewhere herein, in some systems, the presence of adventitious arsenic, antimony, and other such materials form precipitates during operation of flow batteries. While not considered the least bit helpful in the operation of the flow battery or fuel cell, their presence can adversely affect performance. The distinction that an impurity is defined in terms of being unwanted or ill-considered for a chosen redox active electrolyte is relevant, as metals or metalloids that can be considered or even chosen for use as redox active materials in some applications, may be considered impurities when present in other electrolytes. For example, in an electrolyte composition in which a metal ligand coordination compound comprising titanium is the chosen redox active electrolyte, the presence of vanadium in the same electrolyte solution is likely to be seen as an impurity, despite the fact that vanadium is chosen, in other systems, as the primary redox active electrolyte.

As used herein, the term “reduced form of the impurity” connotes a form of the impurity having a lower oxidation state than the impurity in the initial electrolyte solution. For example, where most metals or metalloids exist in solution as impurities as cationic species, or carrying a formal positive charge, as used herein, the metallic form of such an impurity (i.e., having a formal zero valence state) or a hydride form, such as arsine, stibine, germane, etc. have formal negative valence states, and so are considered to be reduced forms of the corresponding impurities. The reduced form of the impurity can include any reduced form of the impurity. In some embodiments, the reduced form of the impurity is volatile. In some embodiments, the reduced form of the impurity is a volatile hydride. Common reduced forms of the impurity include, without limitation, arsine (AsH₃), germane (GeH₄), stannane (SnH₄), stibine (SbH₃), or a combination thereof. In some embodiments, the reduced form of the impurity is AsH₃. In other embodiments, the reduced form of the impurity is GeH₄. In further embodiments, the reduced form of the impurity is SnH₄. In still other embodiments, the reduced form of the impurity is SbH₃. In further embodiments, the reduced form of the impurity is elemental mercury.

As used herein, the terms “metal ligand coordination compounds” or simply “coordination compounds” are known to those skilled in the art of electrochemistry and inorganic chemistry. A (metal ligand) coordination compound can comprise a metal ion bonded to an atom or molecule. The bonded atom or molecule is referred to as a “ligand”. In certain non-limiting embodiments, the ligand can comprise a molecule comprising C, H, N, and/or O atoms. In other words, the ligand can comprise an organic molecule. In some embodiments, the coordination compounds comprise at least one ligand that is not water, hydroxide, or a halide (F⁻, Cl⁻, Br⁻, I⁻), though the invention is not limited to these embodiments. Additional embodiments include those metal ligand coordination compounds described in U.S. Pat. No. 9,768,463, which is incorporated by reference herein in its entirety at least for its teaching of coordination compounds.

As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to the reversible hydrogen electrode.

As used herein, the negative electrode associated with the first aqueous electrolyte of the balancing cell can comprise the same or different materials than the negative electrode of the operating flow batteries, although they share a common electrolyte. By contrast, the positive electrode associated with the second aqueous electrolyte of the balancing cell will almost certainly comprise different materials than the positive electrode of the operating flow battery; in this case, the positive electrolyte of the flow battery will almost certainly be compositionally different, and physically separated from, the second electrolyte of the balancing cell.

The terms “negolyte” and “posolyte,” generally refer to the electrolytes associated with the negative electrode and positive electrodes, respectively. As used herein, however, the terms “negolyte” and “posolyte” are reserved for the respective electrolytes of the flow battery. As contemplated herein, the negative working electrolyte (negolyte) of the flow battery comprises coordination compounds or metal-ligand coordination compounds. In specific embodiments, the negolyte comprises a metal ligand coordination complex having the following formula:

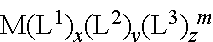

wherein:
M is Al, Ca, Ce, Co, Cr, Fe, Mg, Mn, Mo, Si, Sn, Ti, V, W, Zn, or Zr;
L¹, L², and L³ are each independently ascorbate, a catecholate, citrate, a glycolate or polyol (including ligands derived from ethylene glycol, propylene glycol, or glycerol), gluconate, glycinate, α-hydroxyalkanoate (e.g., α-hydroxyacetate, or from glycolic acid), β-hydroxyalkanoate, γ-hydroxyalkanoate, malate, maleate, phthalate, pyrogallate, sarcosinate, salicylate, or lactate;
x, y, and z are independently 0, 1, 2, or 3, and 1≤x+y+z≤3;
and m is +1, 0, −1, −2, −3, −4, or −5.

Related and independent embodiments provide that (a) x=3, y=z=0; (b) x=2, y=1, z=0; (c) x=1, y=1, z=1; (d) x=2, y=1, z=0; (e) x=2, y=z=0; or (f) x=1, y=z=0. In individual preferred embodiments, M is Al, Cr, Fe, or Ti and x+y+z=3. In more preferred embodiments, the negolyte comprises a metal-ligand coordination compound of titanium. In other preferred embodiments, the negolyte comprises a metal-ligand coordination compound of vanadium.

In other embodiments, the redox active material is described in terms of a compound having the formula:

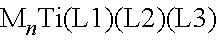

wherein: L1 is a catecholate, and L2 and L3 are each independently selected from catecholates, ascorbate, citrate, glycolates, a polyol, gluconate, glycinate, hydroxyalkanoates, acetate, formate, benzoates, malate, maleate, phthalates, sarcosinate, salicylate, oxalate, a urea, polyamine, aminophenolates, acetylacetone or lactate; each M is independently Na, Li, or K; n is 0 or an integer from 1-6; and provided that when both L1 and L2 are a catecholate, L3 is not oxalate, urea, catecholate or acetylacetone.

In some embodiments, the catecholate comprises 1,2-dihydroxybenzene, 1,2,3-trihydroxybenzene, 1,2,4-trihydroxybenzene or a mixture thereof. Preferred embodiments include compositions having the formula

MₙTi(catecholate)₂(hydroxycatecholate) or MₙTi(catecholate)₃.

In some embodiments, the redox active composition is or comprises one or more compositions having the formula

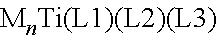

wherein: L1 is a catecholate, and L2 and L3 are each independently selected from catecholates, ascorbate, citrate, glycolates, a polyol, gluconate, glycinate, hydroxyalkanoates, acetate, formate, benzoates, malate, maleate, phthalates, sarcosinate, salicylate, oxalate, a urea, polyamine, aminophenolates, acetylacetone or lactate; each M is independently Na, Li, or K; n is 0 or an integer from 1-6. L1, L2, or L3 can also comprise compound having structure according to Formula I, or an oxidized or reduced form thereof:

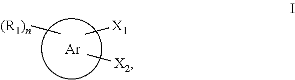

wherein
Ar is a 5-20 membered aromatic moiety, optionally comprising one of more ring O, N, or S heteroatoms;
X₁ and X₂ are independently —OH, —NHR₂, —SH, or an anion thereof, X₁ and X₂ being positioned ortho to one another;
R₁ is independently at each occurrence H, C₁₋₆ alkoxy, C₁₋₆ alkyl, C₁₋₆ alkenyl, C₁₋₆ alkynyl, 5-6 membered aryl or heteroaryl, a boric acid or a salt thereof, carboxy acid or a salt thereof, carboxylate, cyano, halo, hydroxyl, nitro, sulfonate, sulfonic acid or a salt thereof, phosphonate, phosphonic acid or a salt thereof, or a polyglycol (preferably polyethylene glycol);
R₂ is independently H or C₁₋₃ alkyl; and
n is 0, 1, 2, 3, 4, 5, 6, 7, 8, 9, or 10.

Other suitable active materials can comprise an “organic active material”. An organic active material can comprise a molecule or supramolecule that does not contain a transition metal ion. It is further understood that organic active materials are meant to comprise molecules or supramolecules that are dissolved in aqueous solution. Suitable organic active materials are capable of undergoing a change in oxidation state during operation of the electrochemical energy storage system. Accordingly, the molecule or supramolecule can accept or donate an electron during operation of the system.

The terms “a catecholate,” “a glycolate,” “a polyol”, “a hydroxyalkanoate”, “a benzoate”, “a phthalate”, “a urea” and “a polyamine” reflect the fact that these ligands can be optionally substituted with at least one group independently selected from H, C₁₋₆ alkoxy, C₁₋₆ alkyl, C₁₋₆ alkenyl, C₁₋₆ alkynyl, 5-6 membered aryl or heteroaryl, a boric acid or a salt thereof, C₀₋₆ alkylene-carboxy acid or a salt thereof, cyano, halo, hydroxyl, nitro, sulfonate, sulfonic acid or a salt thereof, phosphonate, phosphonic acid or a salt thereof, or a polyglycol (preferably polyethylene glycol).

Alkanoate includes alpha, beta, and gamma forms. Polyamine includes, but is not limited to, diamines and triamines, such as ethylene diamine, ethylene diamine tetraacetic acid (EDTA), and diethylene triamine pentaacetic acid (DTPA). Catecholate includes all compositions comprising a 1,2-dihydroxybenzene moiety. Such moieties include hydroxycatecholates (including pyrogallate), as well as substituents listed herein. Substituents include, but are not limited to, alkyl, alkenyl, and alkynyl (each refer to branched or linear structures and structures optionally substituted with one or more carboxyl, halo, hydroxyl or other electron withdrawing or electron donating groups. Substituents also include 5-6 membered aryl or heteroaryls include phenyl, pyridinyl, furyl, pyrrolyl, imidazolyl, triazole, or thiophenyl. Electron withdrawing or donating substituents can be added to the periphery of the aromatic rings to modulate the redox potential of the redox active ligands.

The terms “parts per million (ppm)” and “parts per billion (ppb)” are defined on a mass basis, relative to the total mass of the electrolyte solution to which the terms are applied. As described elsewhere herein, the terms “mg/mol” and “μg/mol” refers to the concentration an impurity relative to the amount of the redox active electrolyte in the same redox active electrolyte solution.

The term “stack” or “cell stack” or “electrochemical cell stack” refers to a collection of individual electrochemical cells that are electrically connected. The cells can be electrically connected in series or in parallel. The cells may or may not be fluidly connected.

Throughout this text, it is recognized that the descriptions and embodiments refer to methods of preparing impurity-reduced electrolyte solutions, including redox active electrolyte solutions, the impurity-reduced electrolyte solutions themselves, and the electrochemical devices and methods of using these electrochemical devices useful for effecting the methods. Embodiments or descriptions used to describe or characterize any one of these categories should be read as referring to all of these categories. That is, where the disclosure describes and/or claims a feature or embodiment associated with a system or device or a method of making or using a system or device, it is appreciated that such a description and/or claim is intended to extend these features or embodiment to embodiments in each of these contexts (i.e., system, devices, methods, and compositions).

The present disclosure is directed to, inter alia, electrochemical methods and devices for reducing unwanted impurities from redox active electrolytes, in some cases capable of reducing some impurities to low mg/L or mg/mol or even μg/L or μg/mol levels. The disclosure is also directed to electrolyte compositions having such reduced impurity levels and redox batteries incorporating such electrolytes.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

The modifier “about” should be considered as disclosing the range defined by the absolute values of the two endpoints. For example, the expression “from about 2 to about 4” also discloses the range “from 2 to 4.” When used to modify a single number, the term “about” can refer to plus or minus 10% of the indicated number and includes the indicated number. For example, “about 10%” can indicate a range of 9% to 11%, and “about 1” means from 0.9 to 1.1.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

Where present, all ranges are inclusive and combinable. That is, references to values stated in ranges include every value within that range. For example, a range defined as from 400 to 450 ppm includes 400 ppm and 450 ppm as independent embodiments. Ranges of 400 to 450 ppm and 450 to 500 ppm can be combined to be a range of 400 to 500 ppm.

It is to be appreciated that certain features of the invention which are, for clarity, described herein in the context of separate embodiments, can also be provided in combination in a single embodiment. That is, unless obviously incompatible or excluded, each individual embodiment is deemed to be combinable with any other embodiment s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

### EXAMPLES

### Example 1

Trace metallic impurities are removed from negolyte in an electrochemical step which reduces Ti^{IV} to Ti^{III} and dissolved arsenic into arsine which is off-gassed and scrubbed. Hydrogen and oxygen are also gaseous byproducts of this process.

The reduction of titanium is accomplished by cycling the negolyte through an electrochemical system (Hydride Electrochemical Removal Module (HERM)). The corresponding oxidative reaction in the HERM is oxidation of hydroxide to generate oxygen and water.

Once a sufficient quantity of Ti™ has been generated, the arsenic species in solution is converted to arsine gas. Conversion of arsenic to arsine and removal of arsine from the solution is facilitated by heating the negolyte at temperatures >90° C. The Till is converted back to Ti^{IV} with concomitant release of hydrogen by exposure to a metallic surface at temperatures >90° C. The arsine gas produced in the system is captured by a scrubber. The final arsenic concentration should be <10 ppb.

The charging step is completed in three round bottom flasks connected in series with each connected to a separate electrochemical stack. The reactors are connected such that the rate of charging equals the rate of negolyte flowing into and out of the reactor.

At start-up, the first round bottom flask is filled with negolyte and charging started, once the solution potential reaches ⅓ of the target titanium 3+ concentration (10% Ti^{III}) a continuous flow of negolyte into flask 1 is started, a corresponding flow out of flask 1 and into flask 2 is also started. Once flask 2 is filled and reaches ⅔ of the target (20% Till) the flow into flask 3 is started. Once flask 3 reaches the target (35% Ti^{III}) a continuous flow into the gas removal stage is started.

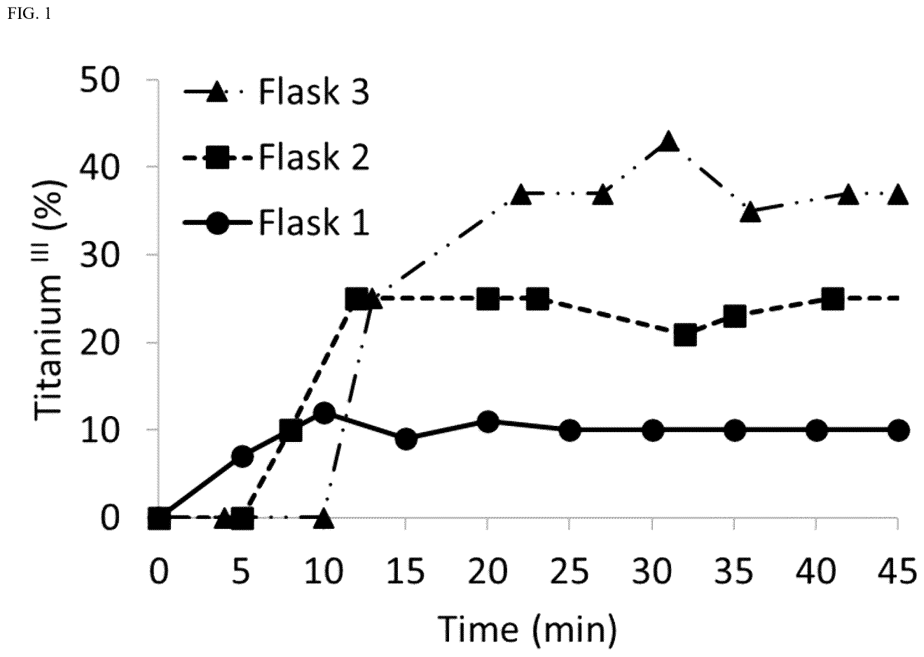

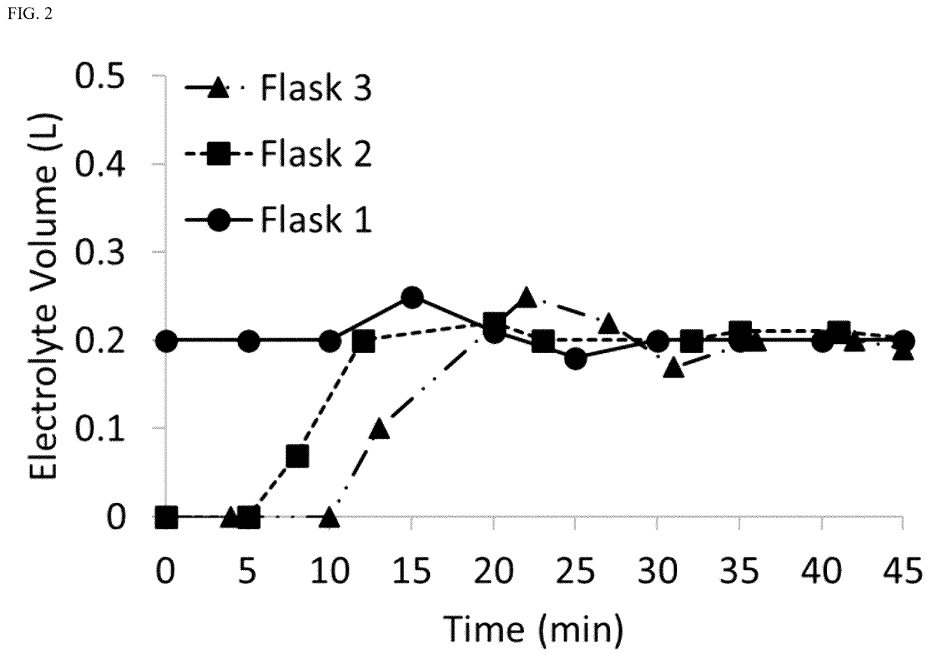

FIG. 1 shows the Titanium 3+ concentration in each flask and FIG. 2 shows the corresponding volume in each flask as the process is started.

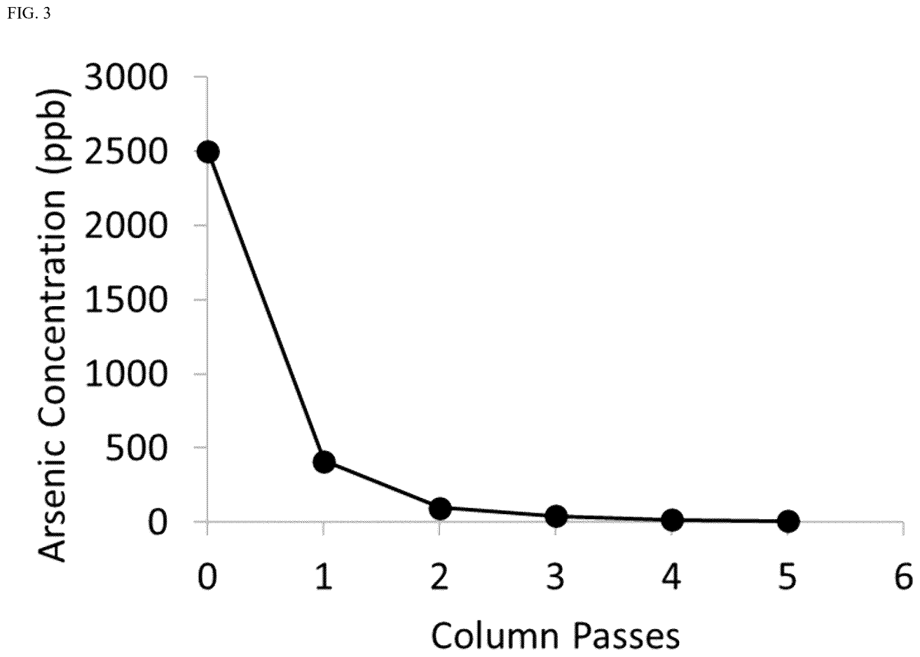

After the target Ti^{III} concentration has been achieved the negolyte is heated and passed through a gas removal column. The column is heated between 90-115° C. and has a high surface area to allow efficient gas removal. Depending on column sizing the negolyte can be circulated through the column until the desired arsenic concentration is achieved. FIG. 3 shows how multiple passes reduces the arsenic concentration as the number of column passes increases.

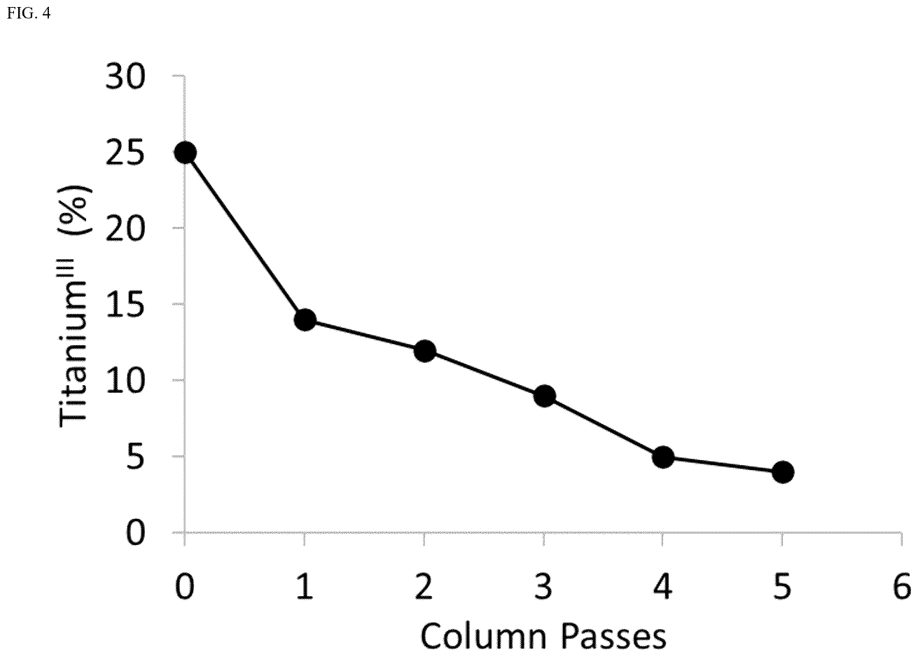

The negolyte is then passed through a steel packed bed column heated between 90-115° C. to convert remaining Ti^{III} back to Ti^{IV}. Hydrogen is evolved as a side product. Depending on column sizing the negolyte can be circulated through the column until the Ti^{III} is fully removed. FIG. 4 shows how multiple passes reduces the Tim concentration as the number of column passes increases.

1. A continuous process for removing an impurity from an electrolyte solution, comprising:
a. selecting an initial electrolyte solution comprising an impurity at an initial concentration and a redox active electrolyte;
b. reducing the electrolyte solution by flowing the initial electrolyte solution through one or more electrochemical reactors to electrochemically reduce at least a portion of the redox active electrolyte to form a reduced form of the redox active electrolyte and electrochemically reduce at least a portion of the impurity to form a reduced form of the impurity in an electrochemically treated electrolyte solution;
c. heating the electrochemically treated electrolyte solution; and
d. flowing the heated electrochemically treated electrolyte solution through a gas removal column to remove the reduced form of the impurity to form a purified electrolyte solution.

2. The process of claim 1, further comprising oxidizing the purified electrolyte solution by flowing the purified electrolyte solution through a vessel comprising metal to oxidize the reduced form of the redox active electrolyte in the purified electrolyte solution to form the redox active electrolyte in a final electrolyte solution.

3. The process of claim 1, wherein the reducing the electrolyte solution step comprises flowing the electrolyte solution sequentially into 2 to 5 electrochemical reactors, wherein in each electrochemical reactor at least a portion of the redox active electrolyte is electrochemically reduced to form a reduced form of the redox active electrolyte or at least a portion of the impurity is electrochemically reduced to form a reduced form of the impurity.

4. The process of claim 3, wherein in the first electrochemical reactor the redox active electrolyte is electrochemically reduced to the reduced form of the redox active electrolyte to result in about 5 mol % to about 30 mol % of the reduced form of the redox active electrolyte out of the total amount of redox active electrolyte in the electrochemically treated electrolyte solution.

5. The process of claim 4, wherein in the last electrochemical reactor the redox active electrolyte is electrochemically reduced to the reduced form of the redox active electrolyte to result in about 25 mol % to about 40 mol % of the reduced form of the redox active electrolyte out of the total amount of redox active electrolyte in the electrochemically treated electrolyte solution.

6. The process of claim 1, wherein each of the electrochemical reactors comprise an electrochemical cell and a vessel; wherein a fraction of the electrolyte solution is circulated through the electrochemical cell.

7. The process of claim 3, wherein the electrolyte solution has a mean residence time in the first electrochemical reactor of from about 1 hour to about 2 hours.

8. The process of claim 1, wherein the heating heats the electrochemically treated electrolyte solution to a temperature in the range of 20° C. to 115° C.

9. The process of claim 1, wherein the heated solution is recirculated though through the gas removal column.

10. The process of claim 9, wherein gas removal column has a surface area such that the liquid passing through the column is able to form a film of about 1 to about 10 mm in thickness over the surface area.

11. The process of claim 9, wherein the heated solution is purged with an inert gas.

12. The process of claim 11, wherein the inert gas is nitrogen or argon.

13. The process of claim 9, wherein the reduced form of the impurity is removed from the heated solution as a volatile gas.

14. The process of claim 2, wherein the vessel comprising metal is a packed bed column.

15. The process of claim 2, wherein the oxidizing is performed at a temperature of about 65° C. to about 130° C., preferably at a temperature of about 85° C. to about 130° C., more preferably at a temperature of about 105° C. to about 130° C.

16. The process of claim 2, wherein the oxidizing is performed using a hydrogen evolution catalyst.

17. The process of claim 16, wherein the hydrogen evolution catalyst comprises any one or more of activated carbon, carbon cloth, carbon felt, carbon paper, Ti mesh, Ti felt, expanded Ti mesh, Pt-plated Ti mesh., stainless steel, and mild steel.

18. The process of claim 6, wherein the electrochemical cell comprises 2-100 cells, preferably 5-11 cells.

19. The process of claim 6, wherein the electrochemical cell has a total stack voltage of 10-300 V, preferably 20-50 V.

20. The process of claim 6, wherein the electrochemical cell operates at a current density of 0.1-0.4 A/cm², preferably 0.1-0.2 A/cm².

21. The process of claim 1, wherein the impurity comprises any one or more of a form of antimony, arsenic, germanium, or tin.

22. The process of claim 1, wherein the reduced form of the impurity is a volatile hydride.

23. The process of claim 22, wherein the volatile hydride comprises any one or more of arsine (AsH₃), germane (GeH₄), stannane (SnH₄), or stibine (SbH₃).

24. The process of claim 3, wherein the reduction step performed in the first electrochemical reaction is at an oxidation reduction potential that is about 25% to 50% of the oxidation reduction potential of the impurity.

25. The process of claim 3, wherein the reduction step performed in the last electrochemical reaction is at an oxidation reduction potential that is about 100% to 150% of the oxidation reduction potential of the impurity.

26. The process of claim 1, wherein the initial electrolyte solution comprises the redox active electrolyte at a concentration of from about 0.5 M to about 2 M.

27. The process of claim 2, wherein the final concentration of the impurity in the final electrolyte solution is:
(i) less than about 10 mg/L, less than 5 mg/L, less than 2.5 mg/L, less than 1 mg/L, less than 500 μg/L, less than 250 μg/L, less than 100 μg/L, less than 50 μg/L, less than about 40 μg/L, less than about 30 μg/L, less than about 20 μg/L, less than about 10 μg/L, less than about 5 μg/L, or less than about 1 μg/L of one or more of a given impurity; or
(ii) less than about 10 mg impurity per mol of the redox active electrolyte in the redox active electrolyte solution (“mg/mol”), less than 5 mg/mol, less than 2.5 mg/mol, less than 1 mg/mol, less than 500 μg/mol, less than 250 μg/mol, less than 100 μg/mol, less than 50 μg/mol, less than about 40 μg/mol, less than about 30 μg/mol, less than about 20 μg/mol, less than about 10 μg/mol, less than about 5 μg/mol, or less than about 1 μg/mol of one or more of a given impurity.

28. The process of claim 1, wherein the redox active electrolyte comprises at least one of
(i) a metal ligand coordination compound comprising any one or more of Al, Ca, Co, Cr, Sr, Cu, Fe, Mg, Mn, Mo, Ni, Pd, Pt, Ru, Sn, Ti, V, Zn, or Zr; and
(ii) an organic active material, preferably carbon, an aromatic hydrocarbon such as a quinone, hydroquinone, viologen, pyridinium, pyridine, acridinium, or catechol, any of which may be unsubstituted, substituted, or combinations thereof.

29. The process of claim 28, wherein the redox active electrolyte comprises a metal ligand coordination compound comprising any one or more of Co, Cr, Cu, Fe, Mn, Mo, Ru, Sn, Ti, V, or Zr.
